(19) United States
(12) Patent Application Publication
(10) Pub. No.: US 2006/0126520 A1
(43) Pub. Date: Jun. 15, 2006

(54) Tape acceleration

(75) Inventors: Manali Nambiar, Sunnyvale, CA (US); Arpakorn Boonkongchuen, San Jose, CA (US); Murali Basavaiah, Sunnyvale, CA (US); Stephen Degroote, Maple Grove, MN (US)

Correspondence Address: BEYER WEAVER & THOMAS LLP, P.O. BOX 70250, OAKLAND, CA, 94612-0250, US

(73) Assignee: Cisco Technology, Inc., San Jose, CA (US)

(21) Appl. No.: 11/015,383

(22) Filed: Dec. 15, 2004

(51) Int. Cl. G06F 15/167; G06F 11/00

(52) U.S. Cl. 370/248; 709/212

(57) ABSTRACT

According to the present invention, methods and apparatus are provided improving data transfers between a host and a tape device on fibre channel fabrics connected through an IP fabric. A fibre channel switch preemptively responds to write requests and data transfers from a host even before acknowledgments are received from a tape device. Flow control and error handling mechanisms are implemented to provide error recovery and to allow accelerated response without overrun.

### BACKGROUND OF THE INVENTION

1. Field of the Invention

The present invention generally relates to Storage Area Networks (SANs). More specifically, the present invention provides techniques and mechanisms for improving data transfers between hosts and end devices coupled to SANs.

2. Description of Related Art

Storage Area Networks (SANs) provide an effective mechanism for maintaining and managing large amounts of data. A host can transfer data through a fibre channel fabric having a number of fibre channel switches to end devices such as tape devices and disk arrays. However, storage area networks are often limited in geographic scope. Fibre channel fabrics in different geographic areas or separate fibre channel fabrics often have limited ability to interoperate.

Protocols such as Fibre Channel over the Internet Protocol (FCIP) allow devices on different fibre channel fabrics to communicate. For example, two separate fibre channel fabrics may be connected through an IP network. A host device on a first fibre channel fabric can send a message to a device on a second fibre channel fabric through the IP network. However, sending messages over an IP network to a separate fibre channel network can often be inefficient. Round trip times for commands and data can often introduce high latency into a network.

Consequently, it is desirable to provide improved techniques for efficiently and effectively transmitting data between fibre channel devices on separate fibre channel networks connected by an IP network.

### SUMMARY OF THE INVENTION

According to the present invention, methods and apparatus are provided improving data transfers between a host and a tape device on fibre channel fabrics connected through an IP fabric. A fibre channel switch preemptively responds to write requests and data transfers from a host even before acknowledgments are received from a tape device. Flow control and error handling mechanisms are implemented to provide error recovery and to allow accelerated response without overrun.

In one example, a method for accelerating a write command is provided. A write command is received from a host in a first fibre channel fabric. The write command is forwarded through a fibre channel over Internet Protocol (IP) tunnel to a storage device in a second fibre channel fabric when flow control is not being enforced. A response with a transfer ready messages is provided to the host before receiving any transfer ready message from the storage device. Write data is received from the host. Write data is forwarded to the storage device and a response with a status good message is provided to the host before any acknowledgment associated with the write data is received from the storage device.

In another example, a fibre channel switch is provided. The fibre channel switch includes a fibre channel interface, a processor and an Internet Protocol (IP) interface. The fibre channel interface is configured to receive write commands and data from a host in a first fibre channel fabric. The processor is configured to determine when transfer ready messages and status good messages should be preemptively sent to the host. The Internet Protocol (IP) interface is configured to forward write commands and data from the host to a storage device in a second fibre channel fabric.

In yet another example, a storage area network is provided. The storage area network includes a first fibre channel switch and a second fibre channel switch. The first fibre channel switch couples a first fibre channel network to an Internet Protocol (IP) network. The first fibre channel network includes a host operable to send write commands and data to the first fibre channel switch. The first fibre channel switch is operable to preemptively send responses to the write commands and data to the host. The second fibre channel switch couples the IP network to a second fibre channel network. The second fibre channel network includes a storage device operable to receive write commands and data and forward write commands and data to the storage device.

A further understanding of the nature and advantages of the present invention may be realized by reference to the remaining portions of the specification and the drawings.

### BRIEF DESCRIPTION OF THE DRAWINGS

The invention may best be understood by reference to the following description taken in conjunction with the accompanying drawings, which are illustrative of specific embodiments of the present invention.

FIG. 1 is a diagrammatic representation showing a system that can use the techniques of the present invention.

FIG. 2 is an exchange diagram showing one example of a write transaction.

FIG. 3 is an exchange diagram showing one example of error handling.

FIG. 4 is a flow process diagram showing processing at a first fibre channel fabric switch.

FIG. 5 is a flow process diagram showing processing at a second fibre channel fabric switch.

FIG. 6 is a diagrammatic representation showing one example of a switch.

### DETAILED DESCRIPTION OF SPECIFIC EMBODIMENTS

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fibre channel and IP networks. However, it should be noted that the techniques of the present invention can be applied to different variations and flavors of fibre channel and any type of intermediate connecting network. In the following description, numerous specific details are set forth in order to provide a thorough understanding of the present invention. The present invention may be practiced without some or all of these specific details. In other instances, well known process operations have not been described in detail in order not to unnecessarily obscure the present invention. Furthermore, techniques and mechanisms of the present invention will sometimes be described in singular form for clarity. However, it should be noted that some embodiments can include multiple iterations of a technique or multiple instantiations of a mechanism unless noted otherwise. For example, a processor is used in a variety of contexts. However, it will be appreciated that multiple processors can also be used while remaining within the scope of the present invention.

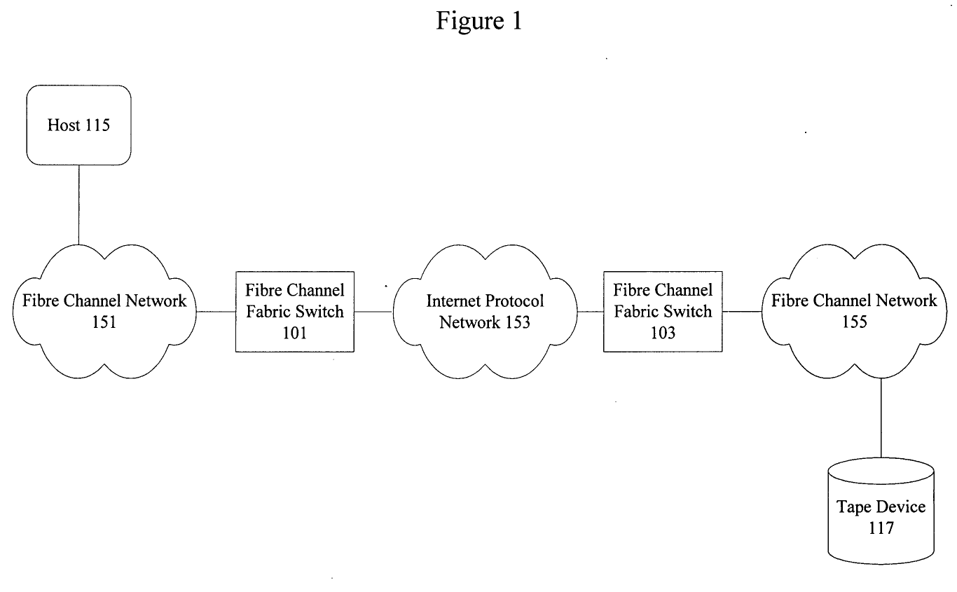

FIG. 1 is a diagrammatic representation showing one example of a system that can use the techniques of the present invention. Multiple fibre channel networks are often interconnected through widely available internet protocol (IP) networks such as the Internet. For example, fibre channel network 151 is connected to internet protocol network 153 using a fibre channel fabric switch 101. The fibre channel fabric switch 101 includes a fibre channel interface as well as an internet protocol interface. Fibre channel network 155 is also connected to internet protocol network 153 through a fibre channel fabric switch 103. The fibre channel fabric switch 103 also includes a fibre channel network interface and an internet protocol interface. The host 115 is connected to fibre channel network 151 and tape device 117 is connected to fibre channel network 155.

In one example, a host 115 sends commands to a tape device 117 through the fibre channel network 151, the internet protocol network 153, and the fibre channel network 155. According to various embodiments, the fibre channel fabric switch 101 establishes a tunnel through the internet protocol network 153 with fibre channel fabric switch 103. Fibre channel fabric switches 101 and 103 are referred to herein as tunnel end points.

However, sending commands and data through multiple networks such as fibre channel network 151, an internet protocol network 153, and a fibre channel network 155 can cause high latency and poor response times. A host 115 would not be able to efficiently send commands and data to a tape device 117. In a standard such as Small Computer Systems Interface (SCSI) for tape devices, only one command can be issued at a time. For each command to complete, the host 115 needs to first receive a response from the destination device 117. For example, in order for a write command to allow a host 115 to begin sending data, the host 115 is required to receive a transfer ready message from a tape device 117. Similarly, before the host can send another write command to the tape device 117, the host 115 expects a status good message from the tape device 117. The wait for transfer ready and status good responses cause a delay of at least two round trip times for every command.

In some instances, a fibre channel fabric switch 101 preemptively sends responses to a host 115 even before responses are returned from a tape device 117. For example, a fibre channel fabric switch 101 can send a transfer ready response as soon as a write command is received from a host 115. Instead of waiting for a transfer ready response from a tape device 117, the host 115 more quickly receives the transfer ready response from the fibre channel fabric switch 101 and can immediately begin transmitting data. Similarly, the fibre channel fabric switch 101 can preemptively send a status good message back to the host 115 to indicate that the data sent by the host 115 was successfully received by the tape device.

The fibre channel fabric switch 101 can send a status good message even before the tape device 117 has received all the data. This allows the host 115 to begin issuing a new command without having to wait for a status good response from the tape device 117. However, preemptively sending transfer ready and status good messages to a host 115 before a tape device 117 generates the responses can lead to several problems.

In one example, flow control problems can occur if a fibre channel fabric switch 101 preemptively sends too many status good messages and transfer ready messages before a tape device 117 is ready to receive additional commands or data. The additional commands or data may end up getting buffered with the risk of buffer overflow. In this example, it is desirable to limit the number of status good messages and transfer ready messages sent to prevent buffer overflow. Consequently, techniques and mechanisms of the present invention allow for flow control to intelligently monitor the amount of data being sent by the host 115.

Similarly, preemptively sending transfer ready and status good messages from a tape device 117 can cause a fibre channel fabric switch 101 to have already sent status good messages even when eventually there may be errors in transmission. For example, a fibre channel fabric switch 101 may send a status good message to a host 115 and after that not all data was successfully transmitted to the tape device 117 through fibre channel network 115. Consequently, the techniques and mechanisms of the present invention provide error handling mechanisms allow preemptive responses to host commands while accounting for possible error scenarios.

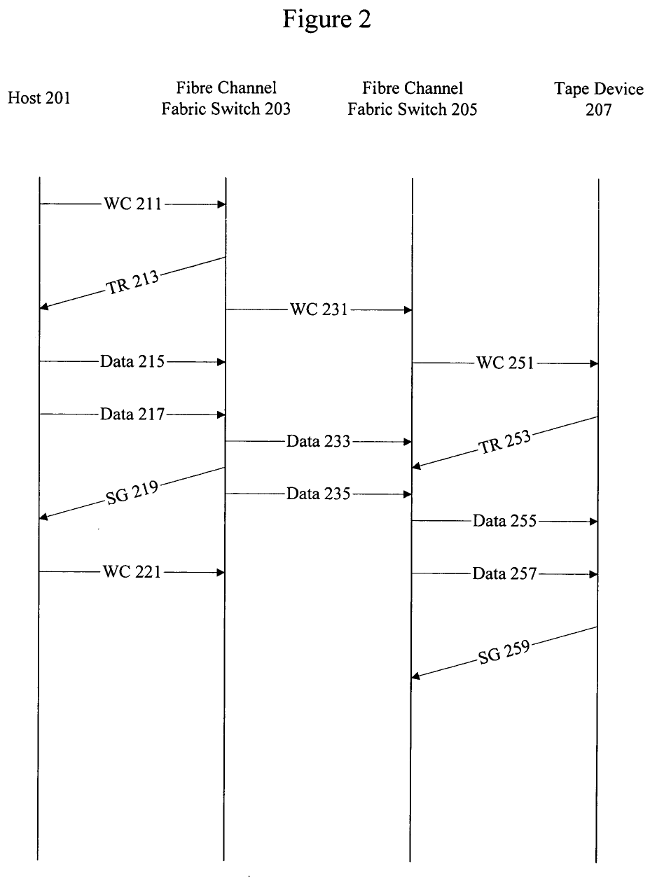

FIG. 2 is an exchange diagram showing one example of tape acceleration. A host 201 sends a write command 211 to a fibre channel fabric switch 203. According to various embodiments, fibre channel fabric switches 203 and 205 are gateways between fibre channel and IP networks. The fibre channel fabric switches 203 and 205 serve as fibre channel over IP (FCIP) tunneling endpoints. The fibre channel fabric switch 203, instead of waiting for a transfer ready from a tape device 207, preemptively sends a transfer ready 213 to the host 201. The fibre channel fabric switch 203 also forwards the write command 231 to a fibre channel fabric switch 205.

The host 201, upon receiving the transfer ready 213, begins sending data 215 and data 217 to the fibre channel fabric switch 203. Data 215 and 217 can be sent to the fibre channel fabric switch 205 even before the write command 251 is received by the tape device 207. According to various embodiments, fibre channel fabric switch 205 is responsible for forwarding a write command 251 to the tape device 207 and receiving a transfer ready 253 before forwarding data 233 and 235 as data 255 and 257. The fibre channel switch 203 can also send a status good message 219 back to the host 201.

According to various embodiments, the fibre channel fabric switch 203 sends the status good message 219 back to the host 201 when it determines that host 201 has finished sending a sequence of data. The end of a sequence of data may be based on transfer lengths and sequence numbers. When the host 201 receives the status good 219, the host 201 can forward another write command 221 to the fibre channel switch 203. The write command 221 is forwarded to the fibre channel fabric switch 205 even before a tape device 207 has responded to data 255 and 257 with its own status good message 259.

According to various embodiments, efficient operation is made possible when a fibre channel fabric switch 205 has enough data to keep a tape device 207 busy at all times. However, a fibre channel fabric switch 205 has limited buffer space. In one embodiment, the channel fabric switch 205 has a buffer per storage device on a storage area network. Consequently, it is ideal for a fibre channel fabric switch 205 to communicate to how much data it should be receiving per storage device on a storage area network. According to various embodiments, fibre channel fabric switch 203 is responsible for sending a transfer ready to a host 201 to control the amount of data being sent for tape device 207. In order to indicate to the host 201 that more data should be sent, a fibre channel fabric switch 205 indicates to a fibre channel fabric switch 203 to allow the transmission of more data when a device buffer associated with a channel fabric switch 205 underflows. The fibre channel fabric switch 205 indicates fibre channel fabric switch 203 to limit the transmission of data when a device buffer associated with a channel fabric switch 205 is sufficiently full. According to various embodiments, a fibre channel fabric switch 203 no longer sends transfer ready messages and status good messages to the host 201 when the device buffer associated with a fibre channel fabric switch 205 is more than 60% full.

A variety of mechanisms can be used to limit or increase the amount of data the host 201 is sending. According to various embodiments meters, counters, and token buckets can be used to control the amount of data sent by the host 201 to a particular tape device. In some embodiments, a fibre channel fabric switch 205 uses a transmit window to control the amount of data sent by host 201. A transmit window is provided on a per device basis. The transmit window can grow in size when a device buffer associated with a channel fabric switch 205 underflows. Any buffer at a tunneling endpoint that is associated with a tape device on the same storage area network is referred to herein as a device buffer. Alternatively, a transmit window can shrink in size when there is risk of device buffer overflow at a channel fabric switch 205.

Transmit windows provide a convenient way of controlling the amount of data sent from host 201 to any particular tape device. Any mechanism used to control the amount of data flowing to a particular buffer associated with a tape device at a fibre channel fabric switch tunneling endpoint is referred to herein as a flow control mechanism.

Although flow control can be handled using mechanisms such as transmit windows, error handling presents another problem for preemptively sending transfer ready messages and status good messages to a host. Any message a host is configured to receive as a request for data transmission for a write command to a tape device is referred to herein as the transfer ready message. Any message a host is configured to receive as an acknowledgment of a completed transmission of a data sequence is referred to herein as a status good message.

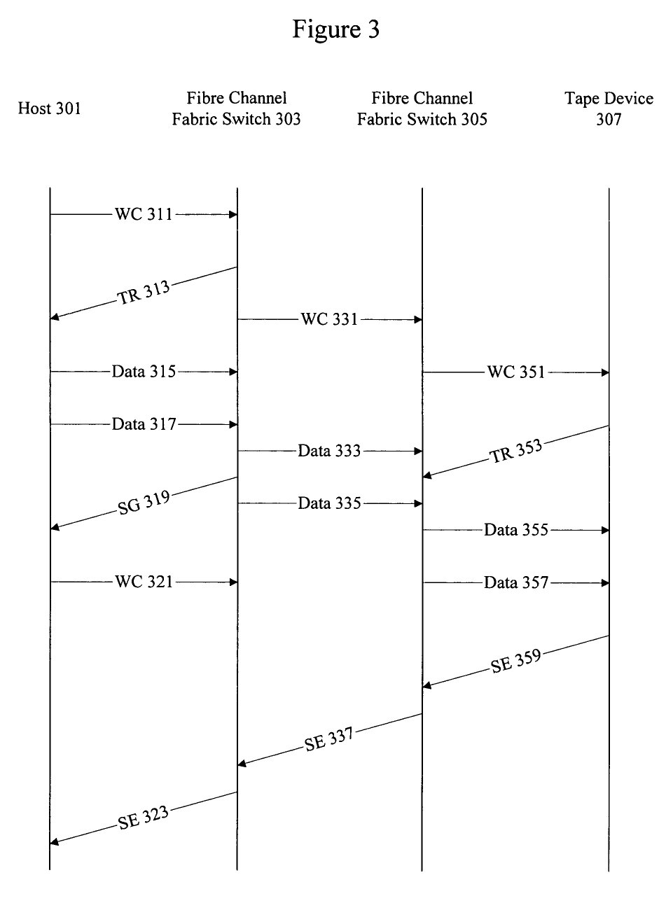

FIG. 3 is an exchange diagram showing one example of error handling. A host 301 sends a write command 311 to a fibre channel fabric switch 303. According to various embodiments, fibre channel fabric switches 303 and 305 are gateways between fibre channel and IP networks. The fibre channel fabric switches 303 and 305 serve as fibre channel over IP (FCIP) tunneling endpoints. The fibre channel fabric switch 303, instead of waiting for a transfer ready from a tape device 307, preemptively sends a transfer ready 313 to the host 301. The fibre channel fabric switch 303 also forwards the write command 331 to a fibre channel fabric switch 305.

The host 301, upon receiving the transfer ready 313, begins sending data 315 and data 317 to the fibre channel fabric switch 303. Data 315 and 317 can be sent to the fibre channel fabric switch 305 even before the write command 351 is received by the tape device 307. According to various embodiments, fibre channel fabric switch 305 is responsible for forwarding a write command 351 to the tape device 307 and receiving a transfer ready 353 before forwarding data 333 and 335 as data 355 and 357. The fibre channel switch 303 can also send a status good message 319 back to the host 301.

According to various embodiments, the fibre channel fabric switch 303 sends the status good message 319 back to the host 301 when it determines that host 301 has finished sending a sequence of data. The end of a sequence of data may be based on transfer lengths and sequence numbers. When the host 301 receives the status good 319, the host 301 can forward another write command 321 to the fibre channel switch 303.

It should be noted that the status good message 319 is transmitted even before there is an acknowledgment by the tape device 307 that data 355 and 357 were successfully received. According to various embodiments, errors may occur in a fibre channel network associated with fibre channel fabric switch 305 and tape device 307. In one example, data can be dropped in the fibre channel fabric. Alternatively, data may be rejected at a tape device 307. If any error is detected by the tape device 307, the tape device 307 sends a status error message 359 back to the fibre channel fabric switch 305. The fibre channel fabric switch 305 forwards a status error message 337 to the fibre channel fabric switch 303. The fibre channel fabric switch 303 may send the status error message 323 to the host 301, depending on the severity level of the error. In some examples, possible error messages include warnings, recoverable errors, or fatal errors. If the error message is a warning, the message can be ignored and the second switch is directed to send all the commands which are queued up at the second switch. Once all the commands are completed, some write commands are allowed to go end-to-end without sending preemptive transfer ready messages and status good messages.

If the messages indicates a recoverable error, the first switch sends the error status to the host, and takes a recovery action based on the next command the host sends to the switch. If it is a fatal error, the first switch sends the status error to the host and directs the second switch to clean up all the commands that are queued. In some examples, the host 301 can then retransmit data associated with the write command even if a subsequent write command 321 has already been forwarded to the fibre channel fabric switch 303.

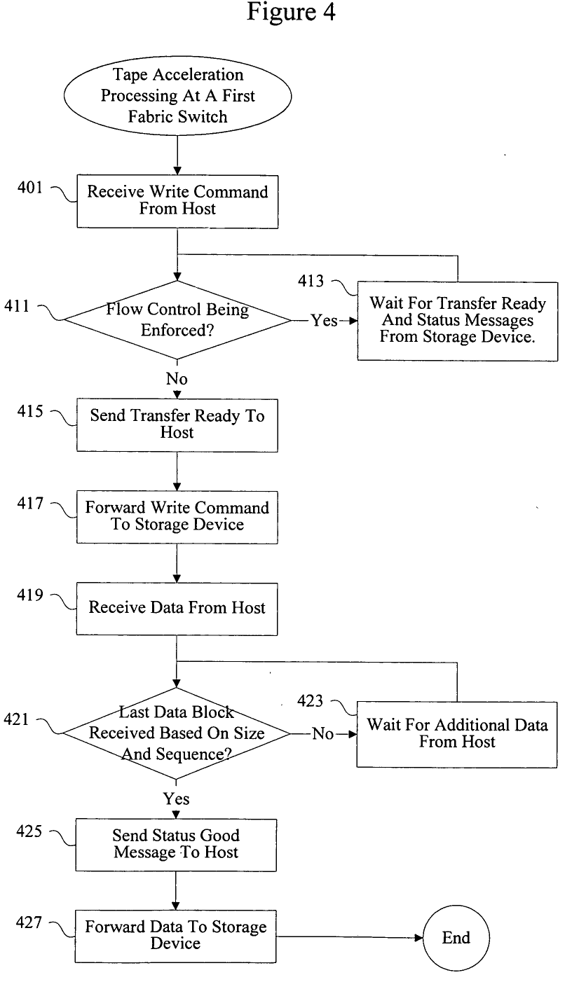

FIG. 4 is a flow process diagram showing acceleration processing at a first fabric switch. At 401, a first fabric switch receives a write command from a host. According to various embodiments, the write command is a SCSI write command that can initiate a write sequence and with a tape device. In this example, the first fabric switch is coupled to a fibre channel network associated with the host and an IP network coupled to a second fibre channel fabric switch. The second fibre channel fabric switch is associated with a second fibre channel network having a tape device. The first fabric switch typically forms a Fibre Channel over IP (FCIP) tunnel with the second fabric switch in order to allow communication between the host and the tape device.

At 411, the first fabric switch determines if flow control is being enforced. If flow control is being enforced at 411, this may mean that the second fibre channel fabric switch does not need more write data to keep the tape device busy. According to various embodiments, the second fabric switch has buffers assigned on a per device basis. At 413, the first fabric switch waits for status message from the storage device sent through the second fabric switch. If flow control is not being enforced, the transfer ready is preemptively sent to the host at 415. By preemptively sending the transfer ready, the host can more quickly begin to transfer data. At 417, the first fabric switch forwards a write command to the storage device. At 419, the first fabric switch receives data from the host. At 421, it is determined if the last data block has been received.

According to various embodiments, the first fabric switch can determine when the last data block is received based on size and sequence numbers. If the last data block has not yet been received, the first fabric switch waits for additional data from the host at 423. After the last data block has been received, a status good message is sent to the host at 425. It should be noted that the status good message is sent to the host even before it is known that the data has been correctly received by the tape device. At 427, data is forwarded to the storage device. It should be noted that certain process steps may be completed in different orders. For example, immediately after the first fabric switch receives data from the host at 419, data can be forwarded to the storage device at 427. Data can be forwarded as the first fabric switch receives the data from the host without waiting for an entire data block to be received.

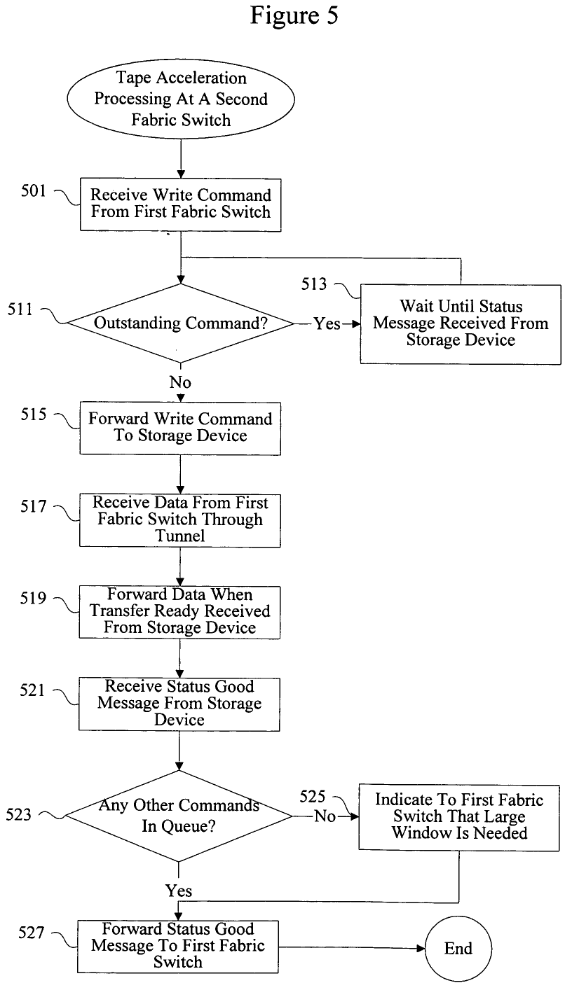

FIG. 5 is a flow process diagram showing tape acceleration processing at a second fabric switch. A 501, a write command is received from a first fabric switch. According to various embodiments, the first fabric switch and a second fabric switch are IP tunnel end points. The first fabric switch is coupled to a fabric network associated with the host and the second fabric switch is coupled to a fabric network associated with a tape device. The two fabric networks communicate through the IP tunnel. At 511, it is determined if there is an outstanding command to the tape device.

According to various embodiments, the tape device can only handle a single command at a time. Consequently, the second fabric switch waits until a status message is received from the storage device at 513. If there is no outstanding command, the write command is forwarded to the storage device at 515. At 517, data is received from the first fabric switch through the FCIP tunnel. At 519, data is forwarded when the transfer ready is received from the storage device. At 521, a status good message is received from the storage device. At 523, it is determined if there are any other commands in the queue. If there are no other commands in the queue, the second fabric switch indicates to the first fabric switch that a larger window is needed at 525. According to various embodiments, using a larger window allows a second fabric switch to always have commands in the queue. Consequently, the tape device can be kept sufficiently busy. At 527, a status good message is forwarded to the first fabric switch.

The techniques of the present invention can be implemented on a variety of network devices such as fibre channel switches and routers. In one example, the techniques of the present invention are implemented on the MDS 9000 series of fibre channel switches available from Cisco Systems of San Jose, Calif.

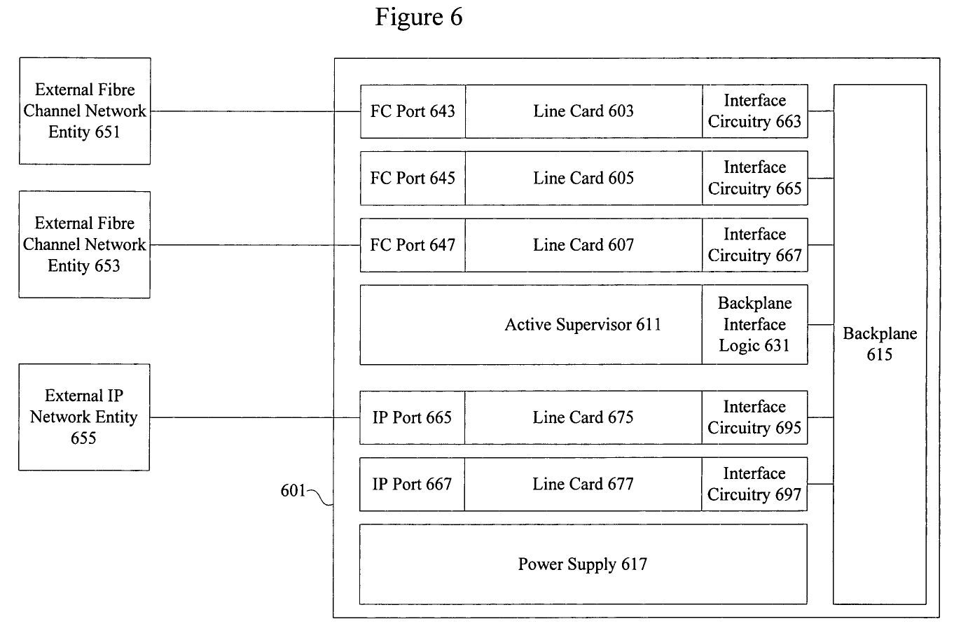

FIG. 6 is a diagrammatic representation of one example of a fibre channel switch that can be used to implement techniques of the present invention. Although one particular configuration will be described, it should be noted that a wide variety of switch and router configurations are available. The tunneling switch 601 may include one or more supervisors 611. According to various embodiments, the supervisor 611 has its own processor, memory, and storage resources.

Line cards 603, 605, and 607 can communicate with an active supervisor 611 through interface circuitry 683, 685, and 687 and the backplane 615. According to various embodiments, each line card includes a plurality of ports that can act as either input ports or output ports for communication with external fibre channel network entities 651 and 653. The backplane 615 can provide a communications channel for all traffic between line cards and supervisors. Individual line cards 603 and 607 can also be coupled to external fibre channel network entities 651 and 653 through fibre channel ports 643 and 647.

External fibre channel network entities 651 and 653 can be nodes such as other fibre channel switches, disks, RAIDS, tape libraries, or servers. It should be noted that the switch can support any number of line cards and supervisors. In the embodiment shown, only a single supervisor is connected to the backplane 615 and the single supervisor communicates with many different line cards. The active supervisor 611 may be configured or designed to run a plurality of applications such as routing, domain manager, system manager, and utility applications.

According to one embodiment, the routing application is configured to provide credits to a sender upon recognizing that a frame has been forwarded to a next hop. A utility application can be configured to track the number of buffers and the number of credits used. A domain manager application can be used to assign domains in the fibre channel storage area network. Various supervisor applications may also be configured to provide functionality such as flow control, credit management, and quality of service (QoS) functionality for various fibre channel protocol layers.

According to various embodiments, the switch also includes line cards 675 and 677 with IP interfaces 665 and 667. In one example, the IP port 665 is coupled to an external IP network entity 655. The line cards 675 and 677 can also be coupled to the backplane 615 through interface circuitry 695 and 697.

According to various embodiments, the switch can have a single IP port and a single fibre channel port. In one embodiment, two fibre channel switches used to form an FCIP tunnel each have one fibre channel line card and one IP line card. Each fibre channel line card connects to an external fibre channel network entity and each IP line card connects to a shared IP network.

In addition, although an exemplary switch is described, the above-described embodiments may be implemented in a variety of network devices (e.g., servers) as well as in a variety of mediums. For instance, instructions and data for implementing the above-described invention may be stored on a disk drive, a hard drive, a floppy disk, a server computer, or a remotely networked computer. Accordingly, the present embodiments are to be considered as illustrative and not restrictive, and the invention is not to be limited to the details given herein, but may be modified within the scope and equivalents of the appended claims.

While the invention has been particularly shown and described with reference to specific embodiments thereof, it will be understood by those skilled in the art that changes in the form and details of the disclosed embodiments may be made without departing from the spirit or scope of the invention. For example, embodiments of the present invention may be employed with a variety of network protocols and architectures. It is therefore intended that the invention be interpreted to include all variations and equivalents that fall within the true spirit and scope of the present invention.

What is claimed is:

1. A method for accelerating a write command, the method comprising:
receiving a write command from a host in a first fibre channel fabric;
forwarding the write command through a fibre channel over Internet Protocol (IP) tunnel to a storage device in a second fibre channel fabric when flow control is not being enforced;
responding to the host with a transfer ready message before receiving any transfer ready message from the storage device;
receiving write data from the host;
forwarding write data to the storage device and responding to the host with a status good message before any acknowledgment associated with the write data is received from the storage device.

2. The method of claim 1, wherein the storage device is a tape device.

3. The method of claim 1, wherein the fibre channel over IP tunnel is established between two gateway switches.

4. The method of claim 3, wherein a first gateway switch couples the first fibre channel fabric to the IP network and a second gateway switch couples the second fibre channel fabric to the IP network.

5. The method of claim 4, wherein the second gateway switch includes a plurality of buffers, the plurality of buffers associated with a plurality of storage devices.

6. The method of claim 5, wherein the write command is forwarded through the fibre channel over IP tunnel if the second gateway switch is determined to have space available in the buffer associated with the storage device.

7. The method of claim 6, wherein second gateway switch buffer space available in the buffer is determined at a first gateway switch by checking a window size.

8. The method of claim 7, wherein the window slides when status good messages are received from the storage device.

9. The method of claim 8, wherein the window grows when the buffer underflows.

10. The method of claim 9, further comprising receiving a storage device initiated transfer ready message.

11. A fibre channel switch, comprising:
a fibre channel interface configured to receive write commands and data from a host in a first fibre channel fabric;
a processor configured to determine when transfer ready messages and status good messages should be preemptively sent to the host;
an Internet Protocol (IP) interface configured to forward write commands and data from the host to a storage device in a second fibre channel fabric.

12. The fibre channel switch of claim 11, wherein the storage device is a tape device.

13. The fibre channel switch of claim 11, wherein the fibre channel over IP tunnel is established between the fibre channel switch and a remote fibre channel switch associated with the second fibre channel fabric.

14. The fibre channel switch of claim 11, wherein transfer ready messages and status good messages are preemptively send to the host when flow control is not being enforced.

15. The fibre channel switch of claim 14, wherein the remove fibre channel switch includes a plurality of buffers, the plurality of buffers associated with a plurality of storage devices.

16. The fibre channel switch of claim 15, wherein the write commands are forwarded through a fibre channel over IP tunnel if the remove fibre channel switch is determined to have space available in the buffer associated with the storage device.

17. The fibre channel switch of claim 16, wherein remote fibre channel switch buffer space available in the buffer is determined at the fibre channel switch by checking a window size.

18. The fibre channel switch of claim 17, wherein the window slides when status good messages are received from the storage device.

19. The fibre channel switch of claim 18, wherein the window grows when the buffer underflows.

20. The fibre channel switch of claim 19, wherein the fibre channel interface is further configured to receive a storage device initiated transfer ready message.

21. A fibre channel switch, comprising:
means for receiving a write command from a host in a first fibre channel fabric;
means for forwarding the write command through a fibre channel over Internet Protocol (IP) tunnel to a storage device in a second fibre channel fabric when flow control is not being enforced;
means for responding to the host with a transfer ready message before receiving any transfer ready message from the storage device;
means for receiving write data from the host;
means for forwarding write data to the storage device and responding to the host with a status good message before any acknowledgment associated with the write data is received from the storage device.

22. The fibre channel switch of claim 21, wherein the storage device is a tape device.

23. The fibre channel switch of claim 21, wherein the fibre channel over IP tunnel is established between two gateway switches.

24. The fibre channel switch of claim 23, wherein a first gateway switch couples the first fibre channel fabric to the IP network and a second gateway switch couples the second fibre channel fabric to the IP network.

25. The fibre channel switch of claim 24, wherein the second gateway switch includes a plurality of buffers, the plurality of buffers associated with a plurality of storage devices.

26. A storage area network, comprising:
a first fibre channel switch coupling a first fibre channel network to an Internet Protocol (IP) network, the first fibre channel network including a host operable to send write commands and data to the first fibre channel switch, wherein the first fibre channel switch is operable to preemptively send responses to the write commands and data to the host;
a second fibre channel switch coupling the IP network to a second fibre channel network, the second fibre channel network including a storage device operable to receive write commands and data and forward write commands and data to the storage device.

27. The storage area network of claim 26, wherein the storage device is a tape device.

28. The storage area network of claim 26, wherein the fibre channel over IP tunnel is established between the fibre channel switch and the second fibre channel switch.

29. The storage area network of claim 26, wherein responses include transfer ready messages and status good messages.

30. The storage area network of claim 29, wherein responses are preemptively sent to the host when flow control is not being enforced.
